(19) United States
(12) Patent Application Publication
(10) Pub. No.: US 2014/0174131 A1
(43) Pub. Date: Jun. 26, 2014

(54) CUTTING METHOD FOR REINFORCED GLASS PLATE AND REINFORCED GLASS PLATE CUTTING DEVICE

(71) Applicant: ASAHI GLASS COMPANY, LIMITED, Chiyoda-ku (JP)

(72) Inventors: Isao SAITO, Tokyo (JP); Yasunari Iwanaga, Tokyo (JP)

(73) Assignee: ASAHI GLASS COMPANY, LIMITED, Chiyoda-ku (JP)

(21) Appl. No.: 14/193,373

(22) Filed: Feb. 28, 2014

Related U.S. Application Data
(63) Continuation of application No. PCT/JP2012/071719, filed on Aug. 28, 2012.

(30) Foreign Application Priority Data
Aug. 31, 2011 (JP) 2011-189048

(51) Int. Cl. C03B 33/08

(52) U.S. Cl. CPC C03B 33/082
USPC 65/112; 65/273

(57) ABSTRACT

The invention relates to a method for cutting a strengthened glass sheet 10, and the strengthened glass sheet 10 including a front surface layer 13 and a rear surface layer 15 which have a residual compressive stress, and an intermediate layer 17 which is formed between the front surface layer 13 and the rear surface layer 15 and has an inside residual tensile stress is cut by moving an irradiation region 22 of the laser beam. In addition, when initiating the cutting of the strengthened glass sheet 10, a thermal stress which induces the generation of a crack is exerted on a cutting initiation location, the extension of the crack is suppressed simultaneously with the generation of the crack at the cutting initiation location, and then the strengthened glass sheet 10 is cut while suppressing the extension of a crack caused by the inside residual tensile stress in the intermediate layer 17.

### TECHNICAL FIELD

The present invention relates to a method for cutting a strengthened glass sheet and an apparatus for cutting a strengthened glass sheet.

### BACKGROUND ART

Recently, in order to improve the protection, appearance and the like of displays (including touch panels), cover glass (protective glass) has been frequently used in mobile devices such as mobile phones or PDAs. In addition, glass substrates are widely used as substrates for displays.

Meanwhile, due to the continuous decrease in the thickness and weight of mobile devices, the thickness of glass sheets being used in mobile devices is also continuously decreased. Since the decrease in the thickness of a glass leads to a decrease in the strength of the glass, strengthened glass including a front surface layer and a rear surface layer in which a compressive stress remains has been developed to compensate for the lack of the strength of glass. The strengthened glass is also used for vehicle window glass and building window glass.

The strengthened glass is produced using, for example, a thermal-tempering-by-air-jets method, a chemical strengthening method or the like. In the thermal-tempering-by-air-jets method, glass having a temperature near the softening point is quenched from the front surface and the rear surface so as to create a temperature difference between the front surface, the rear surface and the inside of the glass, thereby forming a front surface layer and a rear surface layer in which a compressive stress remains. Meanwhile, in the chemical strengthening method, the front and rear surfaces of the glass are ion-exchanged so as to substitute ions with a small ion radius (for example, Li ion and Na ion), which are included in the glass, by ions with a large ion radius (for example, K ion), thereby forming a front surface layer and a rear surface layer in which a compressive stress remains. In both methods, an intermediate layer in which a tensile stress remains is formed between the front surface layer and the rear surface layer as a counteraction.

In a case of manufacturing the strengthened glass, it is more effective to strengthen a glass which is larger than a target product and then cut the glass into multiple pieces than to strengthen glasses having the same size as the target product one by one. Therefore, as a method for cutting a strengthened glass sheet, a method of cutting a strengthened glass by irradiating a laser beam on the surface of the strengthened glass sheet and moving an irradiation region of the laser beam on the surface of the strengthened glass sheet has been proposed (refer to Patent Documents 1 and 2).

### BACKGROUND ART DOCUMENT

### Patent Document

Patent Document 1: JP-A-2008-247732
Patent Document 2: WO 2010/126977

### SUMMARY OF THE INVENTION

### Problems that the Invention is to Solve

When cutting a strengthened glass sheet using a laser beam, it is necessary to optimize the conditions of the laser beam to be irradiated on the strengthened glass sheet in order to stably initiate the cutting of the strengthened glass sheet. That is, if the conditions of the laser beam to be irradiated on the strengthened glass sheet were not optimal when initiating the cutting of the strengthened glass sheet, there was a problem in that there was a case where the strengthened glass sheet did not begin to be cut or a case where a crack extended in an unintended direction such that the cutting line ran off the designed cut line.

In consideration of the above-described problem, an object of the invention is to provide a method for cutting a strengthened glass sheet and an apparatus for cutting a strengthened glass sheet, which can stably initiate the cutting of a strengthened glass sheet.

### Means for Solving the Problems

A method for cutting a strengthened glass sheet according to an embodiment of the invention is a method for cutting a strengthened glass sheet in which a strengthened glass sheet comprising a front surface layer and a rear surface layer which have a residual compressive stress, and an intermediate layer which is provided between the front surface layer and the rear surface layer and has an inside residual tensile stress, is cut by moving an irradiation region of a laser beam to be irradiated on the strengthened glass sheet, wherein, when initiating cutting of the strengthened glass sheet, a thermal stress which induces generation of a crack is exerted on a cutting initiation location in the strengthened glass sheet, and extension of the crack is suppressed simultaneously with the generation of the crack at the cutting initiation location, and then the strengthened glass sheet is cut while suppressing extension of a crack caused by the inside residual tensile stress in the intermediate layer.

An apparatus for cutting a strengthened glass sheet according to an embodiment of the invention is an apparatus for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet, the apparatus comprising: a glass holding and driving unit which holds the strengthened glass sheet and moves the strengthened glass sheet in a predetermined direction; a laser output unit which outputs a laser beam for cutting the strengthened glass sheet; an initial crack-forming unit which forms an initial crack at a cutting initiation location in the strengthened glass sheet; and a control unit which controls the glass holding and driving unit, the laser output unit and the initial crack-forming unit.

### Advantage of the Invention

According to the invention, it is possible to provide a method for cutting a strengthened glass sheet and an apparatus for cutting a strengthened glass sheet, which can stably initiate the cutting of a strengthened glass sheet.

### BRIEF DESCRIPTION OF THE DRAWINGS

FIG. 1 is a cross-sectional view of a strengthened glass sheet.

FIG. 2 is a view illustrating the distribution of a residual stress in the strengthened glass sheet illustrated in FIG. 1.

FIG. 3 is a view for describing a method for cutting a strengthened glass sheet.

FIG. 4 is a cross-sectional view cut along an A-A line in FIG. 3.

FIG. 5 is a cross-sectional view cut along a B-B line in FIG. 3.

FIG. 6A is a view for describing a method for cutting a strengthened glass sheet according to an embodiment.

FIG. 6B is a view for describing a method for cutting a strengthened glass sheet according to the embodiment.

FIG. 6C is a view for describing a method for cutting a strengthened glass sheet according to the embodiment.

FIG. 6D is a view for describing a method for cutting a strengthened glass sheet according to the embodiment.

FIG. 7A is a view for describing a method for cutting a strengthened glass sheet according to the embodiment.

FIG. 7B is a view for describing a method for cutting a strengthened glass sheet according to the embodiment.

FIG. 7C is a view for describing a method for cutting a strengthened glass sheet according to the embodiment.

FIG. 7D is a view for describing a method for cutting a strengthened glass sheet according to the embodiment.

FIG. 8A is a view for describing a method for cutting a strengthened glass sheet according to the embodiment.

FIG. 8B is a view for describing a method for cutting a strengthened glass sheet according to the embodiment.

FIG. 8C is a view for describing a method for cutting a strengthened glass sheet according to the embodiment.

FIG. 9 is a table describing the cutting results of strengthened glass sheets.

FIG. 10 is a table describing the cutting result of a non-strengthened glass sheet.

FIG. 11 is a view for describing an apparatus for cutting the strengthened glass sheet according to the embodiment.

FIG. 12 is a view for describing Example 1 of the invention.

FIG. 13 is a table for describing Example 1 of the invention.

FIG. 14A is a view for describing Example 2 of the invention.

FIG. 14B is a view for describing Example 2 of the invention.

FIG. 15A is a view for describing Example 3 of the invention.

FIG. 15B is a view for describing Example 3 of the invention.

### MODE FOR CARRYING OUT THE INVENTION

Hereinafter, an embodiment of the invention will be described with reference to the accompanying drawings. First, the structure of a strengthened glass sheet and the principle of a method for cutting a strengthened glass sheet will be described.

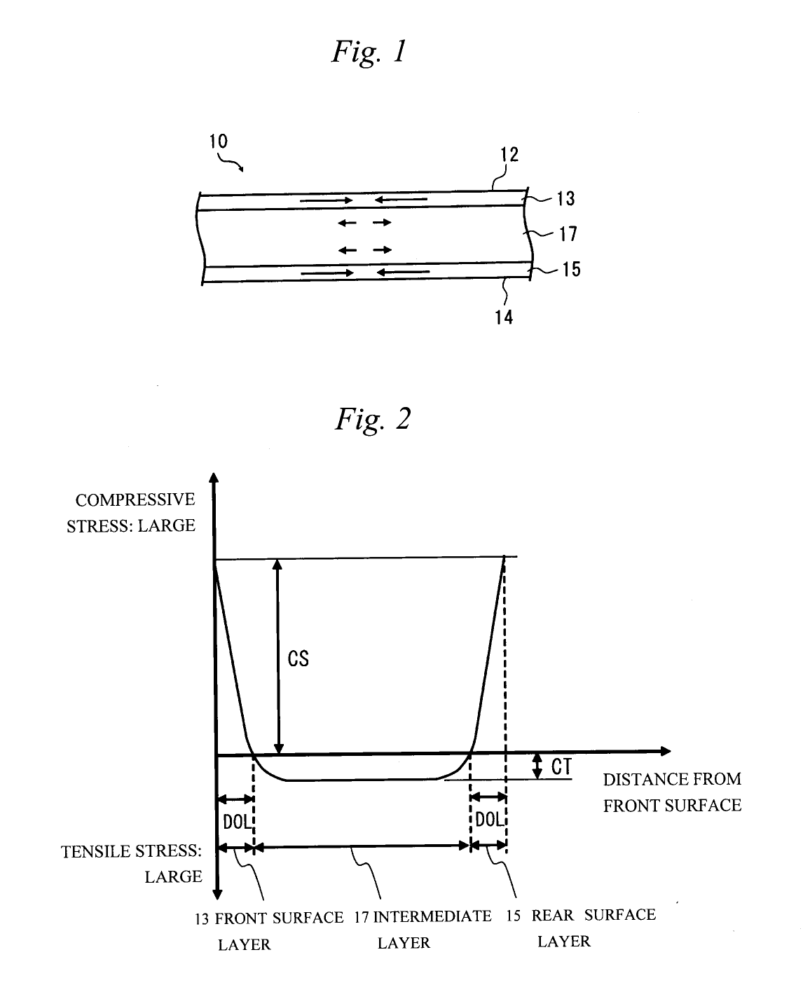

FIG. 1 is a cross-sectional view of a strengthened glass sheet, and FIG. 2 is a view illustrating the distribution of a residual stress in the strengthened glass sheet illustrated in FIG. 1. In FIG. 1, the direction of an arrow represents a stress-acting direction, and the length of an arrow represents the intensity of a stress.

As described in FIG. 1, a strengthened glass sheet 10 includes a front surface layer 13 and a rear surface layer 15 which have a residual compressive stress, and an intermediate layer 17 which is provided between the front surface layer 13 and the rear surface layer 15 and has an inside residual tensile stress. There is a tendency of the residual compressive stress (>0) in the front surface layer 13 and the rear surface layer 15 to gradually decrease toward an inside from a front surface 12 and a rear surface 14 of the strengthened glass sheet 10 as illustrated in FIG. 2. In addition, there is a tendency of the inside residual tensile stress (>0) in the intermediate layer 17 to gradually decrease toward the front surface 12 and the rear surface 14 from the inside of the glass.

In FIG. 2, CS represents the maximum residual compressive stress (surface compressive stress) (>0) in the front surface layer 13 or the rear surface layer 15, CT represents the inside residual tensile stress (the average value of the residual tensile stress in the intermediate layer 17) (>0) in the intermediate layer 17, and DOL represents the thickness of the front surface layer 13 or the rear surface layer 15, respectively. CS, CT and DOL can be adjusted by the conditions of a strengthening treatment. For example, in a case where a thermal-tempering-by-air-jets method is used, CS, CT and DOL can be adjusted by the cooling rate and the like of glass. In addition, in a case where a chemical strengthening method is used, since glass is immersed in a treatment liquid (for example, molten KNO₃ salt) so as to be ion-exchanged, CS, CT and DOL can be adjusted by the concentration, temperature of the treatment liquid, the immersion time, and the like. Meanwhile, the front surface layer 13 and the rear surface layer 15 have the same thickness and the same maximum residual compressive stress, but may have different thicknesses, and may have different maximum residual compressive stresses.

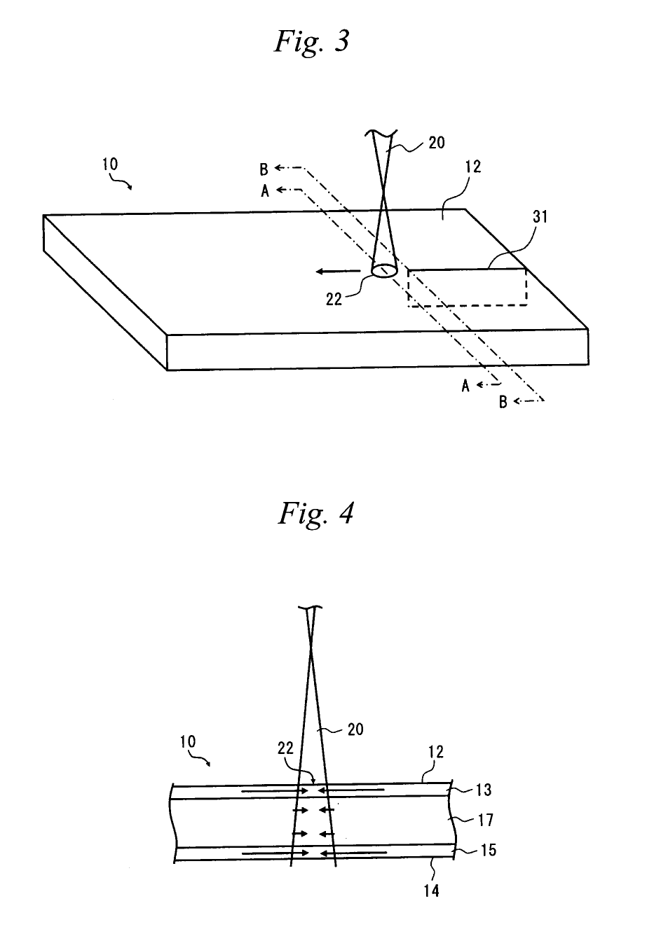

FIG. 3 is a view for describing a method for cutting a strengthened glass sheet. As illustrated in FIG. 3, a laser beam 20 is irradiated on the front surface 12 of the strengthened glass sheet 10, and an irradiation region 22 of the laser beam 20 is moved (scanned) on the front surface 12 of the strengthened glass sheet 10 so as to apply a stress to the strengthened glass sheet 10, thereby cutting the strengthened glass sheet 10.

An initial crack has been formed in advance at a cutting initiation location in an end portion of the strengthened glass sheet 10. The initial crack may be formed using an ordinary method, for example, using a cutter, a file or a laser. In order to decrease the number of processes, the initial crack may not have been formed in advance.

On the front surface 12 of the strengthened glass sheet 10, the irradiation region 22 of the laser beam 20 is moved in a straight line shape or a curved line shape along a designed cut line from the end portion of the strengthened glass sheet 10 toward the inside. Thereby, a crack 31 is formed from the end portion of the strengthened glass sheet 10 toward the inside, and the strengthened glass sheet 10 is cut. The irradiation region 22 of the laser beam 20 may be moved in a P shape, and, in this case, a terminal of a moving path intersects the middle of the moving path.

A light source of the laser beam 20 is not particularly limited, and examples thereof include an UV laser (wavelength: 355 nm), a green laser (wavelength: 532 nm), a semiconductor laser (wavelength: 808 nm, 940 nm, and 975 nm), a fiber laser (wavelength: 1060 nm to 1100 nm), a YAG laser (wavelength: 1064 nm, 2080 nm, and 2940 nm), and a laser using a mid-infrared parametric oscillator (wavelength: 2600 nm to 3450 nm). A method for oscillating the laser beam 20 is not limited, and any one of a CW laser beam which continuously oscillates a laser beam and a pulse laser beam which intermittently oscillates a laser beam can be used. In addition, the intensity distribution of the laser beam 20 is not limited, and the intensity distribution may be a Gaussian type or a top-hat type.

In a case where the strengthened glass sheet 10 and the laser beam 20 satisfy a formula 0<α×t≦3.0, in which α (cm⁻¹) represents the absorption coefficient of the strengthened glass sheet 10 with respect to the laser beam 20 and t (cm) represents the thickness of the strengthened glass sheet 10, it is possible to cut the strengthened glass sheet 10 using not only the action of the laser beam 20 but also the extension of a crack caused by the inside residual tensile stress in the intermediate layer 17. That is, when the intermediate layer 17 in the irradiation region 22 of the laser beam 20 is heated at a temperature equal to or lower than an annealing point under the above-described conditions, it becomes possible to cut the strengthened glass sheet 10 using the crack 31 caused by the inside residual tensile stress by controlling the extension of the crack 31 caused in the strengthened glass sheet 10 using the inside residual tensile stress in the intermediate layer 17. Meanwhile, the reason for heating the intermediate layer 17 at a temperature equal to or lower than an annealing point is that, when the intermediate layer 17 is heated at a temperature higher than the annealing point, the temperature of glass becomes high although the laser beam passes the glass within a short period of time, and there is a high probability of the glass to viscously flow, and therefore the compressive stress generated by the laser beam is relaxed due to the viscous flow.

When the intensity of the laser beam 20 prior to be entered to the strengthened glass sheet 10 is represented by I₀, and the intensity of the laser beam 20 when moving distance L (cm) on the strengthened glass sheet 10 is represented by I, a formula I=I₀×exp(−α×L) is satisfied. This formula is called the Lambert-Beer law.

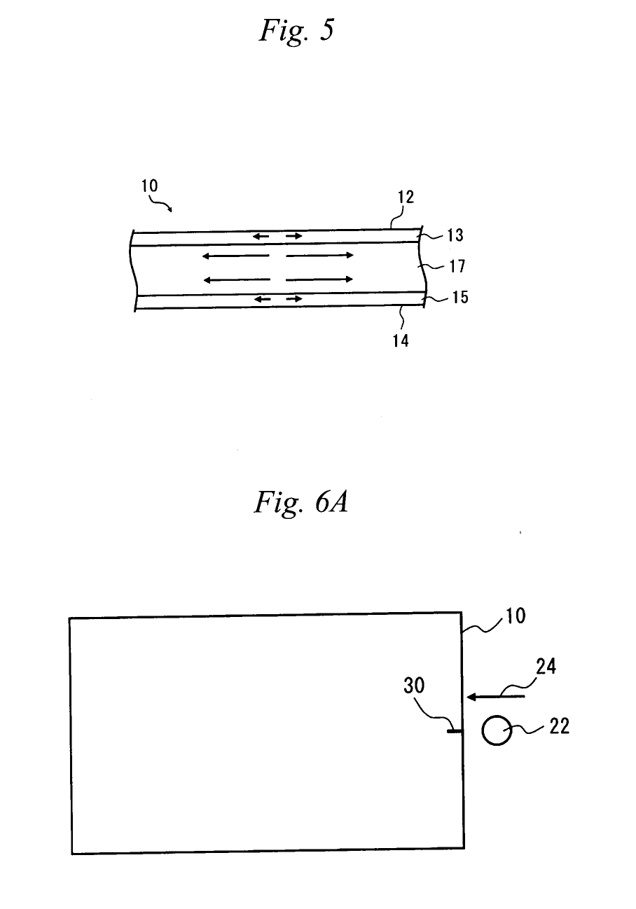

When α×t is set in a range of more than 0 and 3.0 or less, the laser beam 20 can reach the inside without being absorbed in the surface of the strengthened glass sheet 10, and therefore the inside of the strengthened glass sheet 10 can be sufficiently heated. As a result, a stress generated in the strengthened glass sheet 10 is changed into a state illustrated in FIG. 4 or 5 from a state illustrated in FIG. 1.

FIG. 4 is a cross-sectional view cut along an A-A line in FIG. 3, and is a cross-sectional view including the irradiation region of the laser beam. FIG. 5 is a cross-sectional view cut along a B-B line in FIG. 3, and is a cross-section behind the cross-section illustrated in FIG. 4. Here, the “behind” refers to a rear part in a scanning direction of the laser beam 20. In FIGS. 4 and 5, directions of arrows represent the directions in which stresses act, and the lengths of the arrows represent the intensities of stresses.

In the intermediate layer 17 in the irradiation region 22 of the laser beam 20, since the intensity of the laser beam 20 is sufficiently high, the temperature becomes relatively high compared with that of the peripheries, and a tensile stress or a compressive stress which is smaller than the inside residual tensile stress illustrated in FIGS. 1 and 2 is generated. In a portion in which the tensile stress or the compressive stress which is smaller than the inside residual tensile stress is generated, the extension of the crack 31 is suppressed. In order to reliably prevent the extension of the crack 31, it is preferable to generate a compressive stress as illustrated in FIG. 4.

Meanwhile, in the front surface layer 13 or the rear surface layer 15 in the irradiation region 22 of the laser beam 20, since a compressive stress which is larger than the residual compressive stress illustrated in FIGS. 1 and 2 is generated as illustrated in FIG. 4, the extension of the crack 31 is suppressed.

Due to the equilibrium with the compressive stress illustrated in FIG. 4, in the cross-section behind the cross-section illustrated in FIG. 4, a tensile stress is generated in the intermediate layer 17 as illustrated in FIG. 5. The tensile stress is larger than the inside residual tensile stress, and the crack 31 is formed in a portion in which the tensile stress reaches a predetermined value. The crack 31 penetrates the strengthened glass sheet 10 from the front surface 12 to the rear surface 14, and the cutting illustrated in FIG. 3 is a so-called full-cut cutting.

In this state, when the irradiation region 22 of the laser beam 20 is moved, a front end location of the crack 31 moves so as to follow the location of the irradiation region 22. That is, in the cutting method illustrated in FIG. 3, when the strengthened glass sheet 10 is cut, the extension direction of the crack 31 is controlled using a tensile stress (refer to FIG. 5) generated in the rear part in the scanning direction of the laser beam, and the strengthened glass sheet is cut while the extension of the crack 31 is suppressed using the compressive stress (refer to FIG. 4) generated in a region on which the laser beam is irradiated. Therefore, it is possible to suppress the crack 31 to run off the designed cut line to cause the deviant extension.

Depending on usage, glass needs to be highly transparent, and therefore α×t is preferably closer to 0 in a case where the wavelength of a laser beam to be used is closer to the wavelength range of visible light. However, when α×t is too small, the absorption efficiency deteriorates, and therefore α×t is preferably 0.0005 or more (laser beam absorption rate of 0.05% or more), more preferably 0.002 or more (laser beam absorption rate of 0.2% or more), and still more preferably 0.004 or more (laser beam absorption rate of 0.4% or more).

Depending on usage, glass needs to have a low transparency, and therefore α×t is preferably larger in a case where the wavelength of a laser beam to be used is closer to the wavelength range of visible light. However, when α×t is too large, the surface absorption of the laser beam becomes large, and therefore it becomes impossible to control the extension of the crack. Therefore, α×t is preferably 3.0 or less (laser beam absorption rate of 95% or less), more preferably 0.1 or less (laser beam absorption rate of 10% or less), and still more preferably 0.02 or less (laser beam absorption rate of 2% or less).

The absorption coefficient (α) is determined by the wavelength of the laser beam 20, the glass composition of the strengthened glass sheet 10, and the like. For example, as the content of iron oxides (including FeO, Fe₂O₃ and Fe₃O₄), the content of cobalt oxides (including CoO, Co₂O₃ and Co₃O₄) and the content of copper oxides (including CuO and Cu₂O) in the strengthened glass sheet 10 increases, the absorption coefficient (α) in a near infrared wavelength range near 1000 nm increases. Furthermore, as the content of oxides of rare earth elements (for example, Yb) in the strengthened glass sheet 10 increases, the absorption coefficient (α) near the absorption wavelength of rare earth atoms increases.

The absorption coefficient (α) in a near infrared wavelength range near 1000 nm is set depending on usage. For example, in the case of vehicle window glass, the absorption coefficient (α) is preferably set to 3 cm⁻¹ or less. In addition, in the case of building window glass, the absorption coefficient (α) is preferably set to 0.6 cm⁻¹ or less. In addition, in the case of display glass, the absorption coefficient (α) is preferably set to 0.2 cm⁻¹ or less.

The wavelength of the laser beam 20 is preferably in a range of 250 nm to 5000 nm. When the wavelength of the laser beam 20 is set in a range of 250 nm to 5000 nm, the transmittance of the laser beam 20 and the heating efficiency by the laser beam 20 can be both satisfied. The wavelength of the laser beam 20 is more preferably in a range of 300 nm to 4000 nm, and still more preferably in a range of 800 nm to 3000 nm.

The content of iron oxides in the strengthened glass sheet 10 is dependent on the type of glass that configures the strengthened glass sheet 10, and, in the case of soda lime glass, the content of iron oxides is, for example, in a range of 0.02% by mass to 1.0% by mass. When the content of iron oxides is adjusted in the above-described range, it is possible to adjust α×t in a near infrared wavelength range near 1000 nm in a desired range. Instead of the content of iron oxides, the content of cobalt oxides, copper oxides or oxides of rare earth elements may be adjusted.

The thickness (t) of the strengthened glass sheet 10 is set depending on usage, and is preferably in a range of 0.01 cm to 0.2 cm. In the case of chemical strengthened glass, when the thickness (t) is set to 0.2 cm or less, it is possible to sufficiently increase the inside residual tensile stress (CT). On the other hand, when the thickness (t) is less than 0.01 cm, it is difficult to carry out a chemical strengthening treatment on glass. The thickness (t) is more preferably in a range of 0.03 cm to 0.15 cm, and still more preferably in a range of 0.05 cm to 0.15 cm.

When the above-described method is used, it is possible to cut the strengthened glass sheet.

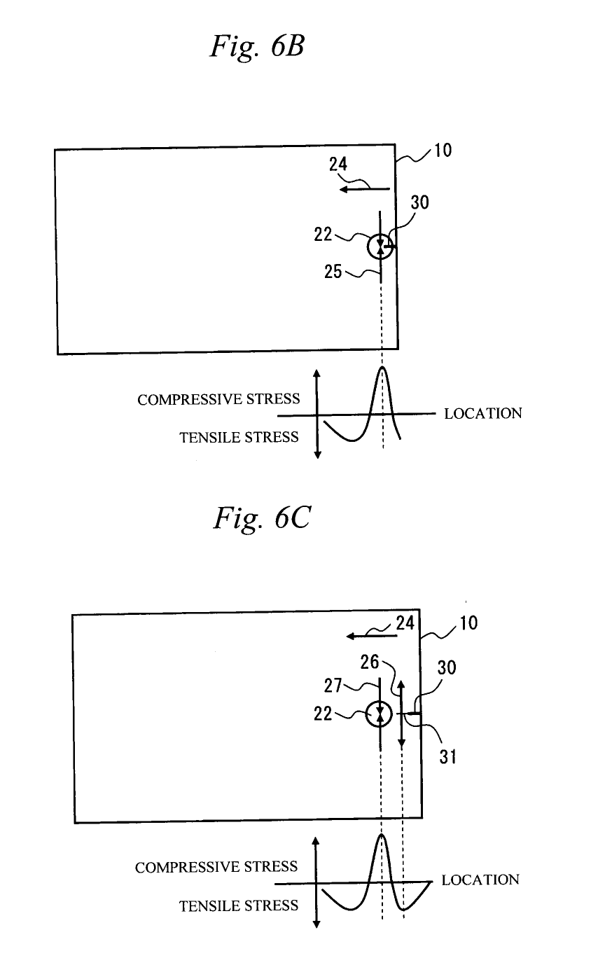

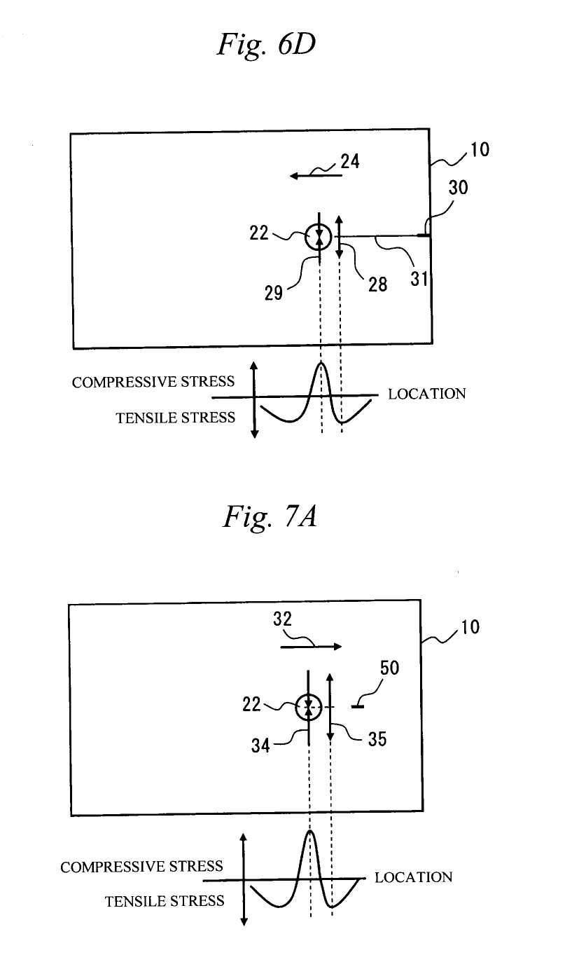

Next, a method for cutting a strengthened glass sheet according to the present embodiment will be described. FIGS. 6A to 6D are views for describing the method for cutting a strengthened glass sheet (first cutting initiation method) according to the present embodiment. FIGS. 6A to 6D are views of a top surface of the strengthened glass sheet 10. In the first cutting initiation method of a strengthened glass sheet according to the present embodiment, the cutting of the strengthened glass sheet 10 is initiated by sequentially moving the irradiation region 22 of the laser beam as illustrated in FIGS. 6A, 6B, 6C and 6D. An arrow 24 illustrated in FIG. 6A indicates the moving direction (scanning direction) of the irradiation region 22 of the laser beam. In addition, graphs illustrated in FIGS. 6B to 6D illustrate the distributions of compressive stresses and tensile stresses acting on the strengthened glass sheet 10 on which the laser beam is irradiated. In addition, in FIGS. 6B to 6D, the directions of arrows 25 to 29 represent stress-acting directions, and the lengths of the arrows 25 to 29 represent the intensities of stresses.

As illustrated in FIG. 6A, an initial crack 30 has been formed in advance at a cutting initiation location in an end portion of the strengthened glass sheet 10 to be cut. The initial crack 30 may be formed using an ordinary method, for example, a cutter, a file or a laser.

Next, as illustrated in FIG. 6B, the irradiation region 22 of the laser beam is moved in a scanning direction 24 so as to pass the initial crack 30 which has been formed in the end portion of the strengthened glass sheet 10. At a timing illustrated in FIG. 6B, the location of the irradiation region 22 of the laser beam overlaps the location of the initial crack 30. At this time, since a compressive stress 25 acts in the irradiation region 22 of the laser beam (refer to FIG. 4), the compressive stress acts on an end portion of the scanning direction side of the initial crack 30. Therefore, in this case, a crack does not extend from the initial crack 30.

Next, as illustrated in FIG. 6C, the irradiation region 22 of the laser beam is further moved in the scanning direction 24. At this time, a compressive stress 27 acts in the irradiation region 22 of the laser beam (refer to FIG. 4), and a tensile stress 26 acts around the irradiation region 22 (refer to FIG. 5). At a timing illustrated in FIG. 6C, since the location of the irradiation region 22 of the laser beam is moved in the scanning direction 24 past the location of the initial crack 30, it is possible to exert the tensile stress 26 generated behind the irradiation region 22 in the scanning direction on the end portion of the scanning direction side of the initial crack 30. Therefore, the crack 31 extends in the scanning direction 24 from the initial crack 30 as an initiation point. At this time, since the compressive stress 27 acts in the irradiation region 22 of the laser beam, the extension of the crack 31 is suppressed. Thereby, the cutting of the strengthened glass sheet 10 is stably initiated. Meanwhile, the compressive stress 27 may be a tensile stress that is smaller than the value of the inside residual tensile stress remaining in the intermediate layer 17.

When initiating the cutting of the strengthened glass sheet 10, it is necessary to exert a thermal stress which induces the extension of the crack on the cutting initiation location. That is, when initiating the cutting, it is necessary to exert the tensile stress 26 large enough to extend the crack 31 from the initial crack 30 on the initial crack 30. Therefore, when initiating the cutting (that is, the timings of FIGS. 6B and 6C), it is necessary to make the irradiation energy per unit length of the laser beam to be irradiated on the strengthened glass sheet 10 larger than the minimum irradiation energy required after the initiation of the cutting.

For example, when the irradiation energy per unit length of the laser beam to be irradiated on the strengthened glass sheet 10 is set to be larger than the irradiation energy per unit length after the initiation of the cutting of the strengthened glass sheet 10 (refer to FIG. 6D), it is possible to increase the tensile stress 26 acting on the initial crack 30 which has been formed at the cutting initiation location in the strengthened glass sheet 10.

Here, when the output of the laser beam is represented by P (W), and the scanning rate of the laser beam is represented by v (mm/s), the irradiation energy E (J/mm) per unit length of the laser beam can be expressed by the following formula (1).

E (J/mm)=P (W)/v (mm/s) (1)

That is, the irradiation energy E (J/mm) per unit length of the laser beam refers to an energy per distance in which the laser beam scans on the strengthened glass sheet 10 for unit time (1 second). Hereinafter, the irradiation energy per unit length of the laser beam will be also expressed as the unit energy.

After the initiation of the cutting of the strengthened glass sheet, as illustrated in FIG. 6D, the irradiation region 22 of the laser beam is further moved in the scanning direction 24, thereby cutting the strengthened glass sheet 10. At a timing illustrated in FIG. 6D, since the cutting of the strengthened glass sheet 10 has already been initiated, it is possible to decrease the tensile stress required for extending the crack 31. That is, after the initiation of the cutting, since the crack is extended by the inside residual tensile stress in the intermediate layer 17, it is possible to make a tensile stress 28 required for extending the crack 31 illustrated in FIG. 6D smaller than the tensile stress 26 required for extending the initial crack 30 illustrated in FIG. 6C. Therefore, after the initiation of the cutting of the strengthened glass sheet 10, the unit energy of the laser beam to be irradiated on the strengthened glass sheet 10 may be set to be smaller than the unit energy of the laser beam at a time of initiating the cutting of the strengthened glass sheet. At this time, since it is necessary to suppress the extension of the crack 31 using the compressive stress in the irradiation region 22, it is necessary to set the unit energy of the laser beam to be equal to or larger than a predetermined value. Needless to say, the unit energy of the laser beam after the initiation of the cutting of the strengthened glass sheet 10 may be set to be equal to the unit energy of the laser beam at a time of initiating the cutting.

Meanwhile, the unit energy of the laser beam to be irradiated on the strengthened glass sheet 10 may be decreased at any timing as long as a tensile stress is exerted on the initial crack 30 and the cutting of the strengthened glass sheet 10 has already been initiated from the location of the initial crack 30. However, in order to more stably initiate the cutting of the strengthened glass sheet 10, the unit energy of the laser beam is preferably decreased after the crack 31 has extended in a predetermined distance from the initial crack 30 as illustrated in FIG. 6C.

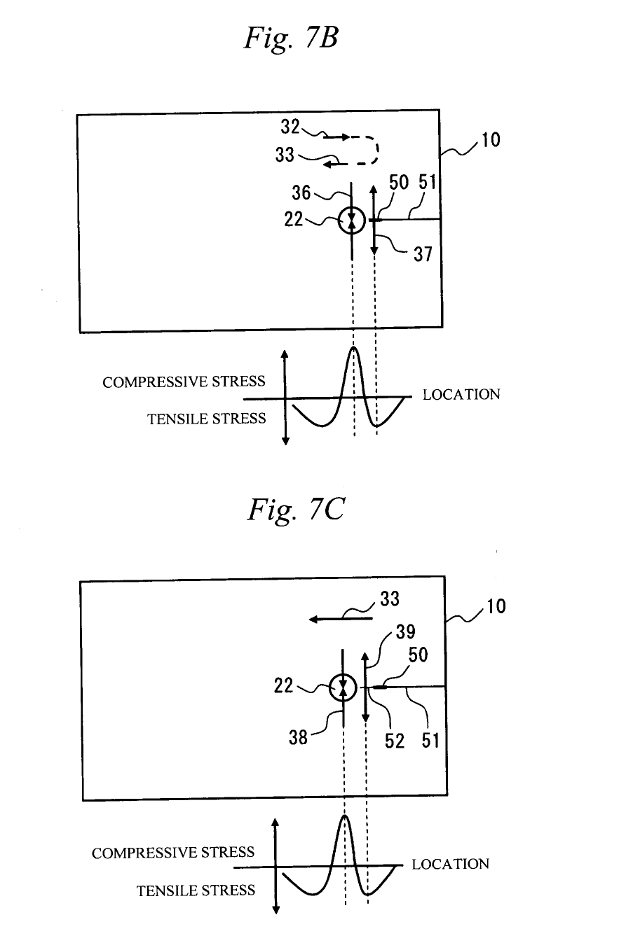

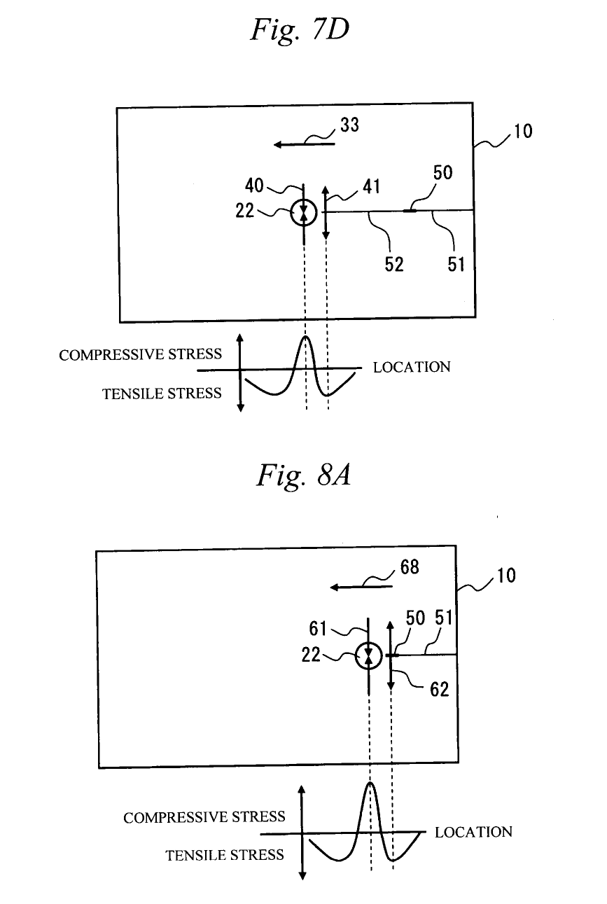

Next, a method for cutting a strengthened glass sheet (second cutting initiation method) according to the embodiment will be described using FIGS. 7A to 7D. FIGS. 7A to 7D are views of the top surface of the strengthened glass sheet 10. In the second cutting initiation method of a strengthened glass sheet according to the present embodiment, first, the irradiation region 22 of the laser beam is moved in a scanning direction 32 as illustrated in FIG. 7A. In addition, after the irradiation region 22 of the laser beam arrives in the vicinity of an initial crack 50, the irradiation region 22 of the laser beam is moved in an opposite direction 33 to the scanning direction 32 (that is, the irradiation region is U-turned) as illustrated in FIG. 7B. After that, the irradiation region 22 of the laser beam is moved in a scanning direction 33 as illustrated in FIGS. 7C and 7D. Graphs illustrated in FIGS. 7A to 7D illustrate the distributions of compressive stresses and tensile stresses acting on the strengthened glass sheet 10 on which the laser beam is irradiated. In addition, in FIGS. 7A to 7D, the directions of arrows 34 to 41 represent stress-acting directions, and the lengths of the arrows 34 to 41 represent the intensities of stresses.

Before cutting the strengthened glass sheet 10, an initial crack 50 has been formed in advance at a cutting initiation location that is inside at a predetermined distance from the end portion of the strengthened glass sheet 10 to be cut as illustrated in FIG. 7A. The initial crack 50 may be formed using an ordinary method, for example, a cutter, a file or a laser. The initial crack 50 may be formed on a surface of the strengthened glass sheet 10, or may be formed inside the strengthened glass sheet 10. In a case where the initial crack is formed inside the strengthened glass sheet 50, a laser is used. In a case where the initial crack is formed inside the strengthened glass sheet 10, it is possible to prevent dust and the like generated when forming the initial crack 50, from diffusing into the surrounding.

In addition, as illustrated in FIG. 7A, the irradiation region 22 of the laser beam is moved in a direction toward the initial crack 50 (that is, the scanning direction 32). At this time, the compressive stress 34 acts in the irradiation region 22 of the laser beam (refer to FIG. 4), and a tensile stress 35 acts around the irradiation region 22 of the light beam. However, at a timing illustrated in FIG. 7A, since the irradiation region 22 of the laser beam is located in front of the initial crack 50, the tensile stress 35 generated by the irradiation of the laser beam does not act on the initial crack 50. Therefore, in this case, a crack does not extend from the initial crack 50.

Next, as illustrated in FIG. 7B, the irradiation region 22 of the laser beam is further moved in the scanning direction 32. In addition, after the irradiation region arrives at a location in which a tensile stress 37 generated ahead in the scanning direction 32 of the laser beam acts on the initial crack 50, the irradiation region 22 of the laser beam is moved in the opposite direction 33 to the scanning direction 32.

At a timing illustrated in FIG. 7B, since the tensile stress 37 generated by the irradiation of the laser beam acts on the initial crack 50, a crack 51 extends toward the end portion of the strengthened glass sheet 10 from the initial crack 50. Since the crack 51 is not suppressed using the compressive stress generated in the irradiation region 22 of the laser beam, there is a case where the crack extends in an unintended direction. Meanwhile, at this time, while the crack tends to extend in the scanning direction 33 from the initial crack 50, since a compressive stress 36 acts on the irradiation region 22 of the laser, the extension of the crack is suppressed. Meanwhile, the compressive stress 36 may be a tensile stress that is smaller than the value of the inside residual tensile stress remaining in the intermediate layer 17.

Meanwhile, the distance that the irradiation region 22 of the laser beam is moved in the scanning direction 32 (refer to FIG. 7A) may be short. For example, the laser beam may be irradiated immediately before the tensile stress 35 illustrated in FIG. 7A acts on the initial crack 50.

Next, as illustrated in FIG. 7C, the irradiation region 22 of the laser beam is further moved in the scanning direction 33. At a timing illustrated in FIG. 7C, a tensile stress 39 generated behind the irradiation region 22 in the scanning direction 33 acts on the initial crack 50, and the crack 52 extends. At this time, since a compressive stress 38 acts on the irradiation region 22 of the laser beam, the extension of the crack 52 is suppressed. Thereby, the cutting of the strengthened glass sheet 10 is stably initiated. Meanwhile, the compressive stress 38 may be a tensile stress that is smaller than the value of the inside residual tensile stress remaining in the intermediate layer 17.

When initiating the cutting of the strengthened glass sheet 10, it is necessary to exert a thermal stress which induces the extension of the crack on the cutting initiation location. That is, when initiating the cutting, it is necessary to exert the tensile stresses 37 and 39 large enough to extend the crack 52 from the initial crack 50, on the initial crack 50. Therefore, when initiating the cutting (that is, the timings of FIGS. 7B and 7C), it is necessary to make the unit energy of the laser beam to be irradiated on the strengthened glass sheet 10 larger than the minimum unit energy of the laser beam required after the initiation of the cutting. Meanwhile, the irradiation energy E (J/mm) per unit length of the laser beam can be obtained using the above-described formula (1).

For example, when the irradiation energy per unit length of the laser beam to be irradiated on the strengthened glass sheet 10 is set to be larger than the irradiation energy per unit length of the laser beam after the initiation of the cutting of the strengthened glass sheet 10 (refer to FIG. 7D), it is possible to increase the tensile stresses 37 and 39 acting on the initial crack 50 which has been formed at the cutting initiation location in the strengthened glass sheet 10.

Meanwhile, in the second cutting initiation method illustrated in FIGS. 7A to 7D, a case where the unit energy of the laser beam in FIG. 7A is set to be equal to the unit energy of the laser beam in FIGS. 7B and 7C has been described as an example. However, the unit energy of the laser beam in FIG. 7A may be set to be smaller than the unit energy of the laser beam in FIGS. 7B and 7C, and the laser beam may not be irradiated until immediately before the timing illustrated in FIG. 7B.

After the initiation of the cutting of the strengthened glass sheet, as illustrated in FIG. 7D, the irradiation region 22 of the laser beam is further moved in the scanning direction 33, thereby cutting the strengthened glass sheet 10. At a timing illustrated in FIG. 7D, since the cutting of the strengthened glass sheet 10 has already been initiated, it is possible to decrease the tensile stress required for extending the crack 52. That is, after the initiation of the cutting, since the crack is extended by the inside residual tensile stress in the intermediate layer 17, it is possible to make a tensile stress 41 required for extending the crack 52 illustrated in FIG. 7D smaller than the tensile stresses 37 and 39 required for extending the initial crack 50 illustrated in FIGS. 7B and 7C. Therefore, after the initiation of the cutting of the strengthened glass sheet 10, the unit energy of the laser beam to be irradiated on the strengthened glass sheet 10 may be set to be smaller than the unit energy of the laser beam at a time of initiating the cutting of the strengthened glass sheet. At this time, since it is necessary to suppress the extension of the crack 52 using the compressive stress in the irradiation region 22, it is necessary to set the unit energy of the laser beam to be equal to or larger than a predetermined value. Needless to say, the unit energy of the laser beam after the initiation of the cutting of the strengthened glass sheet 10 may be set to be equal to the unit energy of the laser beam at a time of initiating the cutting.

Meanwhile, the unit energy of the laser beam to be irradiated on the strengthened glass sheet 10 may be decreased at any timing as long as a tensile stress is exerted on the initial crack 50 and the cutting of the strengthened glass sheet 10 has already been initiated from the location of the initial crack 50. However, in order to more stably initiate the cutting of the strengthened glass sheet 10, the unit energy of the laser beam is preferably decreased after the crack 52 has extended in a predetermined distance from the initial crack 50 as illustrated in FIG. 7C.

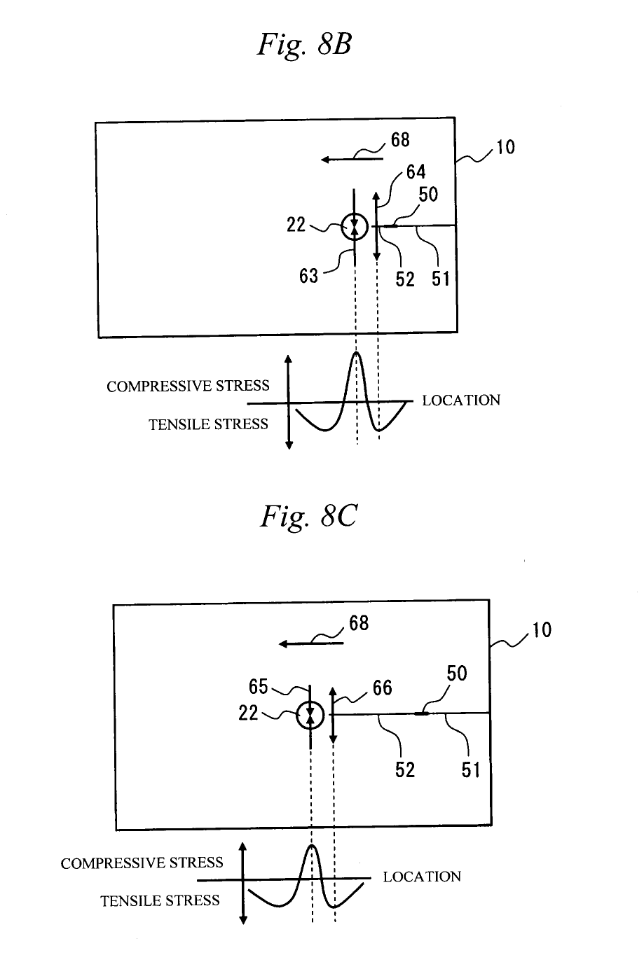

Next, a method for cutting a strengthened glass sheet (third cutting initiation method) according to the present embodiment will be described using FIGS. 8A to 8C. FIGS. 8A to 8C are views of the top surface of the strengthened glass sheet 10. In the third cutting initiation method of a strengthened glass sheet according to the present embodiment, the cutting of the strengthened glass sheet 10 is initiated by initiating the irradiation of the laser beam at a location illustrated in the irradiation region 22 of FIG. 8A, and then moving the irradiation region 22 of the laser beam in an order illustrated in FIGS. 8B and 8C (that is, scanning the irradiation region in a single direction). An arrow 68 illustrated in FIG. 8B indicates the moving direction (scanning direction) of the irradiation region 22 of the laser beam. In addition, graphs illustrated in FIGS. 8A to 8C illustrate the distributions of compressive stresses and tensile stresses acting on the strengthened glass sheet 10 on which the laser beam is irradiated. In addition, in FIGS. 8A to 8C, the directions of arrows 61 to 66 represent stress-acting directions, and the lengths of the arrows 61 to 66 represent the intensities of stresses.

Before cutting the strengthened glass sheet 10, an initial crack 50 has been formed in advance at a cutting initiation location which is inside at a predetermined distance from the end portion of the strengthened glass sheet 10 to be cut. The initial crack 50 may be formed using an ordinary method, for example, a cutter, a file or a laser. The initial crack 50 may be formed on a surface of the strengthened glass sheet 10, or may be formed inside the strengthened glass sheet 10. In a case where the initial crack is formed inside the strengthened glass sheet 50, a laser is used. In a case where the initial crack is formed inside the strengthened glass sheet 10, it is possible to prevent dust and the like generated when forming the initial crack 50 from diffusing into the surrounding.

When initiating the cutting of the strengthened glass sheet 10, the irradiation region 22 of the laser beam is moved in a scanning direction 68 while the laser beam is irradiated on a location illustrated in the irradiation region 22 of FIG. 8A. At this time, a compressive stress 61 acts on the irradiation region 22 of the laser beam (refer to FIG. 4), and a tensile stress 62 acts around the irradiation region 22 of the laser beam. Therefore, when the irradiation region 22 of the laser beam is moved in the scanning direction 68 while the laser beam is irradiated on a location illustrated in the irradiation region 22 of FIG. 8A, it is possible to exert the tensile stress 62 on the initial crack 50. Thereby, the crack 51 extends toward the end portion of the strengthened glass sheet 10 from the initial crack 50. Since the crack 51 is not suppressed using the compressive stress generated in the irradiation region 22 of the laser beam, there is a case where the crack extends in an unintended direction. Meanwhile, at this time, while the crack tends to extend in the scanning direction 68 from the initial crack 50, since a compressive stress 61 acts on the irradiation region 22 of the laser, the extension of the crack is suppressed. Meanwhile, the compressive stress 61 may be a tensile stress that is smaller than the value of the inside residual tensile stress remaining in the intermediate layer 17.

Next, as illustrated in FIG. 8B, the irradiation region 22 of the laser beam is moved in the scanning direction 68. At a timing illustrated in FIG. 8B, a tensile stress 64 generated behind the irradiation region 22 in the scanning direction 68 acts on the initial crack 50, and the crack 52 extends. At this time, since a compressive stress 63 acts on the irradiation region 22 of the laser beam, the extension of the crack 52 is suppressed. Thereby, the cutting of the strengthened glass sheet 10 is stably initiated. Meanwhile, the compressive stress 63 may be a tensile stress that is smaller than the value of the inside residual tensile stress remaining in the intermediate layer 17.

When initiating the cutting of the strengthened glass sheet 10, it is necessary to exert a thermal stress which induces the extension of the crack on the cutting initiation location. That is, when initiating the cutting, it is necessary to exert the tensile stresses 62 and 64 large enough to extend the crack 52 from the initial crack 50, on the initial crack 50. Therefore, when initiating the cutting (that is, the timings of FIGS. 8A and 8B), it is necessary to make the unit energy of the laser beam to be irradiated on the strengthened glass sheet 10 larger than the minimum unit energy of the laser required after the initiation of the cutting. Meanwhile, the irradiation energy E (J/mm) per unit length of the laser beam can be obtained using the above-described formula (1).

For example, when the irradiation energy per unit length of the laser beam to be irradiated on the strengthened glass sheet 10 is set to be larger than the irradiation energy per unit length of the laser beam after the initiation of the cutting of the strengthened glass sheet 10 (refer to FIG. 8C), it is possible to increase the tensile stresses 62 and 64 acting on the initial crack 50 which has been formed at the cutting initiation location in the strengthened glass sheet 10.

After the initiation of the cutting of the strengthened glass sheet, as illustrated in FIG. 8C, the irradiation region 22 of the laser beam is further moved in the scanning direction 68, thereby cutting the strengthened glass sheet 10. At a timing illustrated in FIG. 8C, since the cutting of the strengthened glass sheet 10 has already been initiated, it is possible to decrease the tensile stress required for extending the crack 52. That is, after the initiation of the cutting, since the crack is extended by the inside residual tensile stress in the intermediate layer 17, it is possible to make a tensile stress 66 required for extending the crack 52 illustrated in FIG. 8C smaller than the tensile stresses 62 and 64 required for extending the initial crack 50 illustrated in FIGS. 8A and 8B. Therefore, after the initiation of the cutting of the strengthened glass sheet 10, the unit energy of the laser beam to be irradiated on the strengthened glass sheet 10 may be set to be smaller than the unit energy of the laser beam at a time of initiating the cutting of the strengthened glass sheet. At this time, since it is necessary to suppress the extension of the crack 52 using the compressive stress in the irradiation region 22, it is necessary to set the unit energy of the laser beam to be equal to or larger than a predetermined value. Needless to say, the unit energy of the laser beam after the initiation of the cutting of the strengthened glass sheet 10 may be set to be equal to the unit energy of the laser at a time of initiating the cutting.

Meanwhile, the unit energy of the laser beam to be irradiated on the strengthened glass sheet 10 may be decreased at any timing as long as a tensile stress is exerted on the initial crack 50 and the cutting of the strengthened glass sheet 10 has already been initiated from the location of the initial crack 50. However, in order to more stably initiate the cutting of the strengthened glass sheet 10, the unit energy of the laser beam is preferably decreased after the crack 52 has extended in a predetermined distance from the initial crack 50 as illustrated in FIG. 8B.

As described above, in the first to third cutting initiation methods of a strengthened glass sheet according to the present embodiment, when initiating the cutting of the strengthened glass sheet 10, a thermal stress which induces the occurrence of crack is exerted on the initial cracks 30 and 50 (cutting initiation locations) so as to generate the cracks 31 and 52 in the initial cracks 30 and 50, and then the extension of the crack caused by the inside residual tensile stress in the intermediate layer 17 behind the irradiation region 22 in the scanning direction is suppressed. Therefore, it is possible to extend the cracks 31 and 52 in the scanning direction from the initial crack 30 or 50 as an initiation point, and it is possible to stably initiate the cutting of the strengthened glass sheet 10.

In the first to third cutting initiation methods described above, it is possible to increase the irradiation energy per unit length of the laser beam by, for example, increasing the output (power) of the laser beam. In addition, it is possible to increase the irradiation energy per unit length of the laser beam by decreasing the moving rate (scanning rate) of the irradiation region 22 of the laser beam.

In the method for cutting a strengthened glass sheet according to the present embodiment, when the area of the radiation area 22 of the laser beam is too small, a region on which the compressive stress generated in the irradiation region 22 of the laser beam acts or a region on which the tensile stress generated in the irradiation region 22 of the laser beam acts becomes small. Therefore, in a case where the irradiation region 22 of the laser beam is slightly deviated from the location of the initial crack 30 or 50, there is no tensile stress acting on the initial crack 30 or 50, and there is a case where the cutting of the strengthened glass sheet 10 does not initiate. Therefore, in the method for cutting a strengthened glass sheet according to the present embodiment, the area of the irradiation region 22 of the laser beam is preferably set to a predetermined value or higher to increase the probability in which the tensile stress generated around the irradiation region 22 of the laser beam acts on the initial crack 30 or 50. Therefore, the beam radius at a time of initiating the cutting may be set to be large compared with the beam radius after the initiation of the cutting.

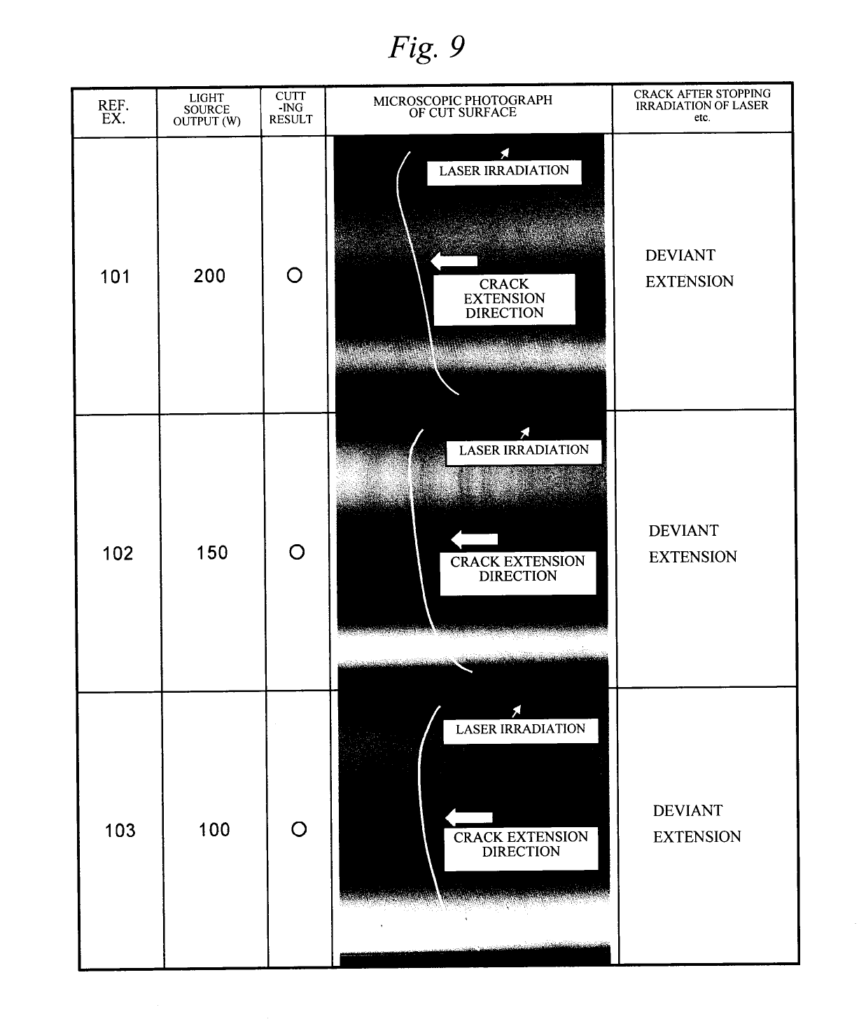

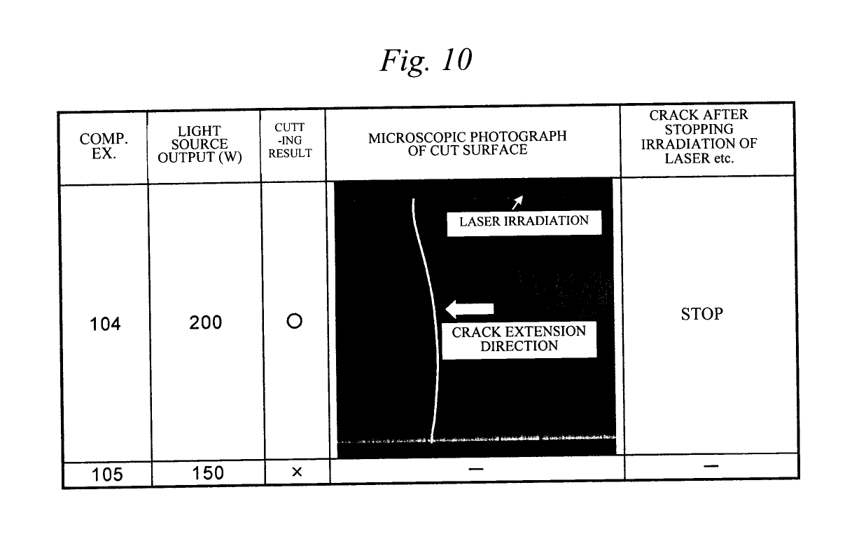

Next, with reference to FIGS. 9 and 10, the fact that the patterns of the extension of cracks are different in the method for cutting a strengthened glass sheet and in a method for cutting a non-strengthened glass sheet. FIG. 9 is a table describing the cutting results of strengthened glass sheets, and FIG. 10 is a table describing the cutting result of a non-strengthened glass sheet.

In Reference Examples 101 to 103, strengthened glass sheets were prepared, and, in Comparative Examples 104 and 105, non-strengthened glass sheets were prepared. The strengthened glass sheets in Reference Examples 101 to 103 were produced by strengthening a glass sheet having the same dimensions and shape (rectangular shape, long side being 100 mm, short side being 60 mm, and sheet thickness of 0.7 mm) and the same chemical composition as the non-strengthened glass sheets in Comparative Examples 104 and 105 using the chemical strengthening method. The strengthened glass sheets had an inside residual tensile stress (CT) of 30.4 MPa, a maximum residual compressive stress (CS) of 763 MPa, and a thickness (DOL) of a compressive stress layer (front surface layer or rear surface layer) of 25.8 μm.

In Reference Examples 101 to 103 and Comparative Examples 104 and 105, cutting tests were carried out under the same conditions except for the type of the glass sheet (strengthened or non-strengthened) and the output of the light source.

<Common Conditions>

Light source of the laser beam: fiber laser (wavelength of 1070 nm)

Incident angle of the laser beam on the glass sheet: 0°

Converging angle of the laser beam: 2.5°

Converging location of the laser beam: a location 23 mm away from the surface of the glass sheet toward the light source

Diameter of the laser beam spot on the surface of the glass sheet: 41 mm

Absorption coefficient (α) of the glass sheet with respect to the laser beam: 0.09 cm⁻¹

Thickness of the glass sheet (t): 0.07 cm

Young's modulus (E) of the glass sheet: 74000 MPa

α×t: 0.0063

Diameter of the nozzle outlet: φ1 mm

Flow rate of the cooling gas (compressed air at room temperature) from the nozzle: 30 L/min

Intended cutting location: a straight line in parallel with the short side of the glass sheet (10 mm away from one short side and 90 mm away from the other short side)

Cutting rate: 2.5 mm/s

After cutting, the cut surface of the glass sheet was observed using a microscope. The stripe shape observed on the cut surface of the glass sheet indicates the change over time of the front end location of a continuously extending crack. The pattern of the extension of the crack can be found from each of the stripe shapes. In the microscopic photographs illustrated in FIGS. 9 and 10, representative lines of the stripe shapes are stressed using thick white lines.

In addition, the shapes of the cracks caused when the laser beam irradiation and the gas cooling were stopped in the middle of the cutting of the glass sheet were visually observed.

The test results of Reference Examples 101 to 103 and Comparative Examples 104 and 105 are described in FIGS. 9 and 10. In FIGS. 9 and 10, a case where a crack was formed in the glass sheet (a case where the glass sheet could be cut) was indicated as “O”, and a case where a crack was not formed in the glass sheet (a case where the glass sheet could not be cut) was indicated as “X”. The lines of the stripe shapes on the microscopic photographs of the cut surfaces of FIGS. 9 and 10 indicate the locations of the front ends of the cracks at a certain point of time. The “deviant extension” in FIGS. 9 and 10 means that the crack extends toward a short side of the two short sides of the glass sheet which is closer to the cutting location after stopping the irradiation of the laser beam and the like.

In the cutting of the non-strengthened glass sheet according to Comparative Examples 104 and 105, as is evident from the microscopic photographs of the cut surfaces, there was a tendency that both end portions of the glass sheet in the sheet thickness direction were broken prior to the central portion of the glass sheet in the sheet thickness direction. In addition, when the laser beam irradiation and the gas cooling were stopped in the middle of the cutting, the extension of the crack stopped. In addition, in the cutting of the non-strengthened glass sheet, a large output of the light source was required.

In contrast, in the cutting of the strengthened glass sheet according to Reference Examples 101 to 103, as is evident from the microscopic photographs of the cut surfaces, there was a tendency that the central portion of the glass sheet in the sheet thickness direction was broken prior to both end portions of the glass sheet in the sheet thickness direction. This is because the inside tensile stress is originally present in the strengthened glass sheet and the crack extends due to the inside residual tensile stress. In addition, when the laser beam irradiation and the gas cooling were stopped in the middle of the cutting, the crack extended in an unintended direction on its own. From the above-described result, it is found that the extension of the crack due to the residual tensile stress can be suppressed using the irradiation of a laser beam.

As described above, in the method for cutting a strengthened glass sheet and the method for cutting a non-strengthened glass sheet, the cutting mechanisms are fundamentally different, and the patterns of the extension of the crack are totally different. Therefore, in the invention, it is possible to obtain effects that cannot be expected from the method for cutting non-strengthened glass. The reason for what has been described above will be described below.

For example, in the method for cutting a non-strengthened glass sheet, a thermal stress field is formed in the glass sheet using both a laser beam and a cooling liquid so as to generate a tensile stress necessary for cutting. More specifically, a laser beam is irradiated on the glass sheet so as to generate a thermal stress in the glass sheet, a compressive stress generated by the thermal stress is quenched using a cooling liquid so as to generate a tensile stress, thereby extending the crack. Therefore, the crack is extended using only the irradiation energy of the laser beam, and it is necessary to set the power (W) of the laser beam to be irradiated on the glass sheet to be large.

In the above-described method, the front end location of a cutting fissure formed in the glass sheet is determined by the location of the cooling liquid that cools the glass sheet. This is because a tensile stress is generated in the location of the cooling liquid. Therefore, when heating using a laser beam and cooling using the cooling liquid are stopped in the middle of the cutting, the crack is stopped from extending.

In contrast, in the method for cutting a strengthened glass sheet, since a residual tensile stress is originally present in the glass sheet, unlike the case of the cutting of a non-strengthened glass sheet, it is not necessary to generate a tensile stress using a laser beam. In addition, therefore, when a certain force is exerted on the strengthened glass sheet so as to generate a crack, the crack extends on its own due to the inside residual tensile stress. On the other hand, since the inside residual tensile stress is present throughout the inside of the glass sheet, the crack extends in an unintended direction as long as the extension of the crack is not controlled.

Therefore, in the invention, a tensile stress or a compressive stress, which is smaller than the value of the inside residual tensile stress is formed in the intermediate layer at the center of the irradiation region, thereby suppressing the extension of the crack caused by the inside residual tensile stress. That is, the extension of the crack is controlled by decreasing the residual tensile stress in the intermediate layer in the strengthened glass sheet using the irradiation of the laser beam.

As described above, in the method for cutting a strengthened glass sheet and the method for cutting a non-strengthened glass sheet, the patterns of the extension of the crack are different.

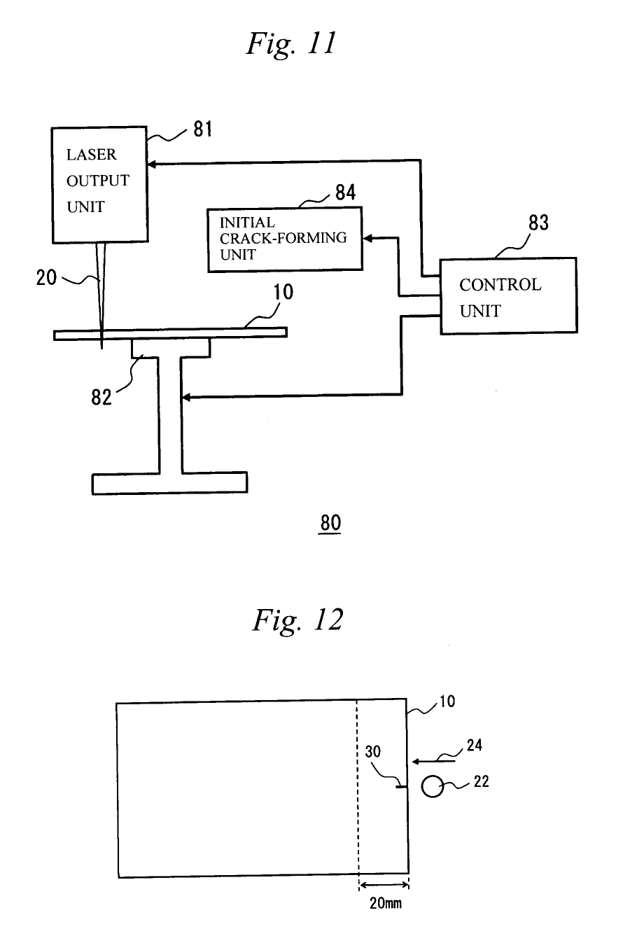

Next, an apparatus for cutting a strengthened glass sheet for carrying out the method for cutting a strengthened glass sheet according to the present embodiment, which has been described above, will be described. FIG. 11 is a view for describing an apparatus for cutting the strengthened glass sheet according to the present embodiment. An apparatus for cutting a strengthened glass sheet 80 according to the embodiment includes a laser output unit 81, a glass holding and driving unit 82, a control unit 83 and an initial crack-forming unit 84.

The laser output unit 81 outputs the laser beam 20 for cutting the strengthened glass sheet 10. Examples of a light source of the laser beam 20 include a UV laser (wavelength: 355 nm), a green laser (wavelength: 532 nm), a semiconductor laser (wavelength: 808 nm, 940 nm, and 975 nm), a fiber laser (wavelength: 1060 nm to 1100 nm), a YAG laser (wavelength: 1064 nm, 2080 nm, and 2940 nm), and a laser using a mid-infrared parametric oscillator (wavelength: 2600 nm to 3450 nm). The laser output unit 81 includes an optical system for adjusting the focal point of the laser beam. In addition, a nozzle may be disposed in an irradiation portion of the laser beam. The power of the laser beam (laser output), the beam diameter (focal point) of the laser beam, the timing of laser irradiation, and the like are controlled using the control unit 83.

Here, in a case where a near infrared laser beam is used, it is necessary to add impurities such as Fe to the strengthened glass sheet to increase the absorption in a near infrared range. In a case where impurities having an absorption characteristic in a near infrared range are added, since the absorption characteristic in a visible light range is also influenced, there is a case where the color or transmittance of the strengthened glass sheet is influenced. In order to prevent the above-described influence, a mid-infrared laser having a wavelength in a range of 2500 nm to 5000 nm may be used as the light source of the laser beam 20. At a wavelength in a range of 2500 nm to 5000 nm, since absorption due to the molecular vibration of the glass itself generates, it is not necessary to add impurities such as Fe.

The glass holding and driving unit 82 holds the strengthened glass sheet 10 which is a workpiece and moves the strengthened glass sheet 10 in a predetermined direction. That is, the glass holding and driving unit 82 moves the strengthened glass sheet 10 so that the laser beam scans the strengthened glass sheet 10 along the designed cut line. The glass holding and driving unit 82 is controlled using the control unit 83. The glass holding and driving unit 82 may fix the strengthened glass sheet 10 which is a workpiece using a porous sheet or the like. In addition, the glass holding and driving unit 82 may include an image detector for determining the location of the strengthened glass sheet 10. When an image detector for location determination is included, it is possible to improve the process accuracy of the strengthened glass sheet 10.

Meanwhile, in the apparatus for cutting a strengthened glass sheet 80 illustrated in FIG. 11, the strengthened glass sheet 10 is moved using the glass holding and driving unit 82 so that the irradiation region of the laser beam 20 moves on the strengthened glass sheet 10. At this time, the laser output unit 81 is fixed. However, the irradiation region of the laser beam 20 may be moved on the strengthened glass sheet 10 by fixing the strengthened glass sheet 10 being held in the glass holding and driving unit 82 and moving the laser output unit 81. In addition, both the strengthened glass sheet 10 being held in the glass holding and driving unit 82 and the laser output unit 81 may be configured to be movable.

The initial crack-forming unit 84 forms an initial crack at the cutting initiation location in the strengthened glass sheet 10. For example, an apparatus including a mechanism which forms an initial crack in the strengthened glass sheet 10 using a laser beam can be used as the initial crack-forming unit 84. In this case, it is possible to use an apparatus which can output a pulse laser having a pulse width of several tens of ns or less at a wavelength in a range of 300 nm to 1100 nm. In addition, it is possible to form an initial crack in the strengthened glass sheet 10 by setting the focal location of the pulse laser in the strengthened glass sheet 10. Thereby, it is possible to prevent dust and the like generated when forming the initial crack 50 from diffusing into the surrounding. In addition, for example, the initial crack-forming unit 84 may be an apparatus including a mechanism which mechanically forms an initial crack in the strengthened glass sheet 10. When the apparatus includes the laser output portion 81 and the initial crack-forming unit 84 like an apparatus for cutting a strengthened glass sheet 80 illustrated in FIG. 11, it is possible to form an initial crack and cut the strengthened glass sheet 10 at the same time in a state that the strengthened glass sheet 10 which is a workpiece is fixed to the same glass holding and driving unit 82.

The control unit 83 controls the laser output unit 81, the glass holding and driving unit 82 and the initial crack-forming unit 84. For example, the control unit 83 can determine the irradiation energy per unit length of the laser beam to be irradiated on the strengthened glass sheet in accordance with at least one of the thermal expansion coefficient and thickness of the strengthened glass sheet 10, the absorption coefficient of the strengthened glass sheet with respect to the laser beam, and the inside residual tensile stress in the intermediate layer 17 in the strengthened glass sheet. In addition, the control unit 83 can control the area (that is, the beam diameter φ) of the irradiation region of the laser beam, the output of the laser beam, and the scanning rate of the laser beam in accordance with the designed cut line of the strengthened glass sheet 10.

As described above, the invention according to the present embodiment enables the provision of a method for cutting a strengthened glass sheet and an apparatus for cutting a strengthened glass sheet, which can stably initiate the cutting of a strengthened glass sheet.

### EXAMPLES

Hereinafter, examples of the invention will be described. In Example 1, an example which corresponds to the first cutting initiation method described in the embodiment will be described. In Example 2, an example which corresponds to the second cutting initiation method described in the embodiment will be described. In Example 3, an example which corresponds to the third cutting initiation method described in the embodiment will be described.

### Example 1

In Example 1, a strengthened glass sheet having a sheet thickness of 1.1 (mm), a surface compressive stress CS of 739 (MPa), a thickness DOL of each of the front surface layer and the rear surface layer of 40.3 (μm) and an inside residual tensile stress CT of 29.2 (MPa) was used.

The inside residual tensile stress CT of the strengthened glass sheet was obtained as follows. The surface compressive stress CS and the thicknesses DOL of the compressive stress layers (the front surface layer and the rear surface layer) were measured using a surface stress meter FSM-6000 (manufactured by Orihara Industrial Co., Ltd.) and the inside residual tensile stress was calculated from the measured values and the thickness t of the strengthened glass sheet using the following formula (2).

CT=(CS×DOL)/(t−2×DOL) (2)

The strengthened glass sheet was cut using the first cutting initiation method described in the embodiment. That is, an initial crack 30 was formed in advance in the cutting initiation location at an end portion of the strengthened glass sheet 10 as illustrated in FIG. 12, and a laser beam was scanned in a direction 24 so that the irradiation region 22 of the laser beam passed the initial crack 30. In addition, the laser beam was driven under the initial conditions (initial rate) up to 20 mm inside the strengthened glass sheet 10 from the end portion of the strengthened glass sheet 10. A fiber laser (central wavelength band of 1070 nm) was used as the light source of the laser beam. In addition, the beam radius of the laser beam was set to 0.1 (mm).

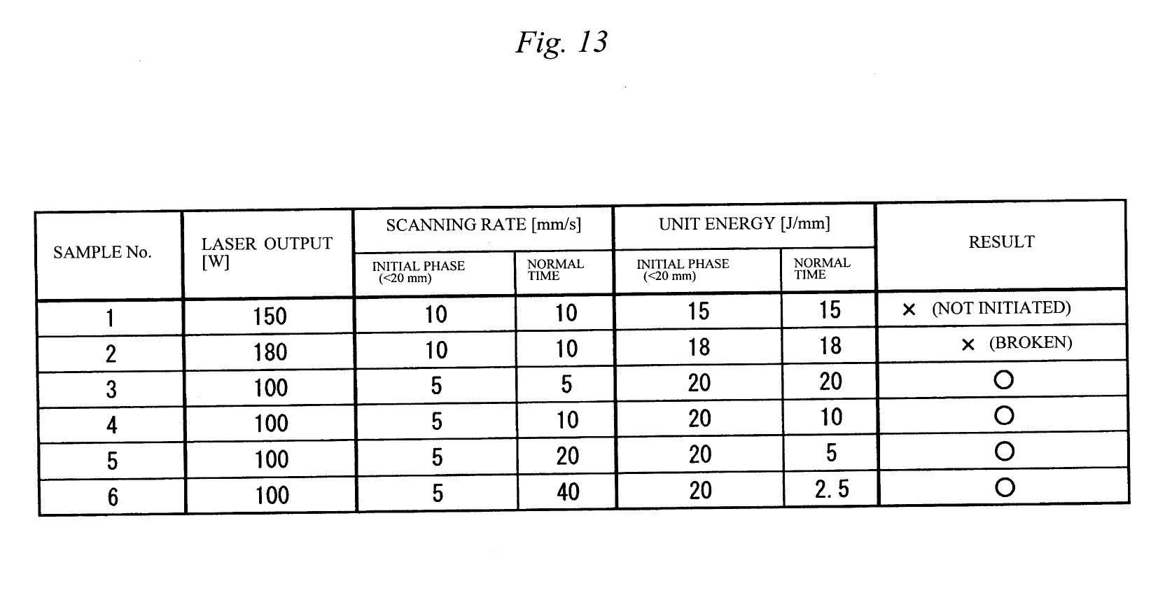

FIG. 13 describes the cutting conditions and the cutting results of the strengthened glass sheets. The table described in FIG. 13 shows the laser beam output (W), the scanning rate (mm/s) of the laser beam at the initial phase (<20 mm) and during normal time, and the unit energy E (J/mm) at the initial phase (<20 mm) and during normal time as the conditions for cutting each of Sample Nos. 1 to 6. Here, the unit energy E (J/mm) of the laser beam at the initial phase and during normal time was obtained by substituting the laser beam output (W) and the scanning rate (mm/s) of the laser beam at the initial phase and during normal time into the above-described formula (1).

The cutting result was indicated as “O” in a case where the cutting of the strengthened glass sheet was initiated along the designed cut line, and was indicated as “X” in a case where the cutting was not initiated and the glass was crushed.

As described in FIG. 13, in a case where the value of the unit energy E of the laser beam at the initial phase (<20 mm) was 15 (J/mm) or 18 (J/mm) (Sample Nos. 1 and 2), the cutting was not normally initiated. That is, in Sample No. 1, since the thermal stress which induced the extension of the crack from the initial crack was not sufficient, the cutting was not initiated. In addition, in Sample No. 2, since the thermal stress generated in the irradiation region of the laser beam was not sufficient, it was not possible to suppress the extension of the induced crack, and the strengthened glass sheet 10 was broken. On the other hand, in a case where the value of the unit energy E of the laser beam was 20 (J/mm) at the initial phase (<20 mm) (Sample Nos. 3 to 6), it was possible to normally initiate the cutting.

In Sample No. 3, the strengthened glass sheet was cut at the same scanning rate, that is, with the same unit energy even after the initiation of the cutting, but it was possible to normally continue the cutting of the strengthened glass sheet. In Sample No. 4, the scanning rate of the laser beam was changed from 5 (mm/s) to 10 (mm/s) when the scanning distance of the laser beam exceeded 20 (mm) after the initiation of the cutting. Thereby, while the unit energy of the laser beam was changed from 20 (J/mm) to 10 (J/mm), it was possible to normally continue the cutting of the strengthened glass sheet. In addition, in Sample No. 5, the scanning rate of the laser beam was changed from 5 (mm/s) to 20 (mm/s) when the scanning distance of the laser beam exceeded 20 (mm) after the initiation of the cutting. Thereby, while the unit energy of the laser beam was changed from 20 (J/mm) to 5 (J/mm), it was possible to normally continue the cutting of the strengthened glass sheet. In addition, in Sample No. 6, the scanning rate of the laser beam was changed from 5 (mm/s) to 40 (mm/s) when the scanning distance of the laser beam exceeded 20 (mm) after the initiation of the cutting. Thereby, while the unit energy of the laser beam was changed from 20 (J/mm) to 2.5 (J/mm), it was possible to normally continue the cutting of the strengthened glass sheet.

From the results described in FIG. 13, it can be said that the energy per unit length of the laser beam needs to be increased when initiating the cutting of the strengthened glass sheet 10 compared with when the strengthened glass sheet 10 is ordinarily cut (after the initiation of the cutting). Specifically, it can be said that, when initiating the cutting of the strengthened glass sheet 10, the energy per unit length of the laser beam needs to be set to 20 (J/mm) or more. In addition, after the initiation of the cutting, the energy per unit length of the laser beam can be decreased to 2.5 (J/mm).

### Example 2

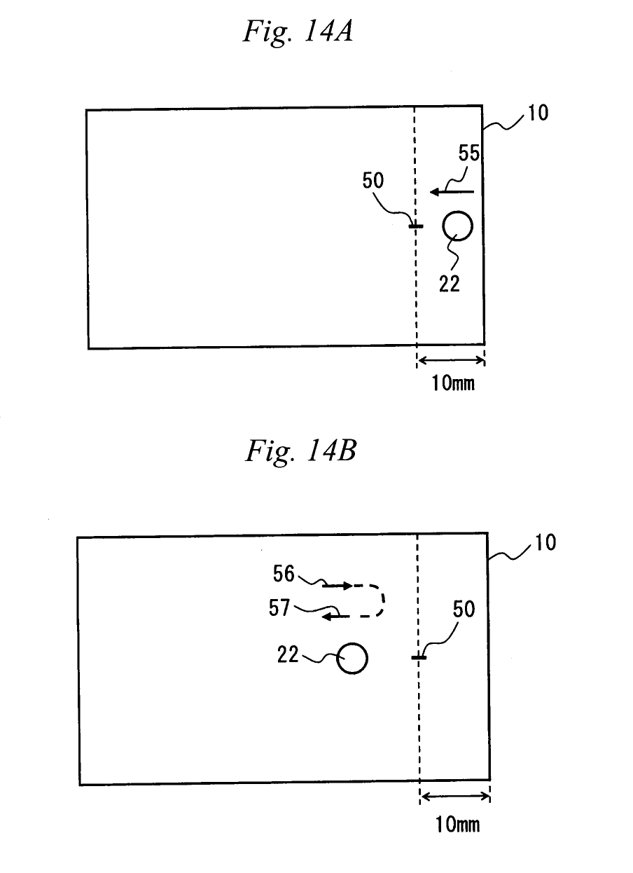

Next, Example 2 of the invention will be described. In Example 2, a strengthened glass sheet having a sheet thickness of 0.9 (mm) and an internal residual tensile stress CT of 55 (MPa) was used. In addition, the initial crack 50 was formed in advance 10 mm inside from the end portion of the strengthened glass sheet 10 as illustrated in FIGS. 14A and 14B. In Example 2, the irradiation region 22 of the laser beam was moved in the following three test patterns.

The irradiation region 22 of the laser beam was moved in a direction 55 from the end portion of the strengthened glass sheet 10 as illustrated in FIG. 14A. At this time, tests were carried out for a case where the laser beam began to be irradiated from a location 1 mm to 5 mm ahead of the initial crack 50 (test pattern 1) and a case where the laser beam began to be irradiated from a location 0 mm to 0.5 mm ahead of the initial crack 50 (test pattern 2).

In addition, the irradiation region 22 of the laser beam was moved toward the initial crack 50 (that is, in a direction 56) from the inside of the strengthened glass sheet 10, and the scanning direction of the laser beam was reversed (in a direction 57) ahead of the initial crack 50 (test pattern 3) as illustrated in FIG. 14B. When scanning the laser beam in the direction 56, the laser beam began to be irradiated at a location 0.5 mm ahead of the initial crack 50 (that is, a location 0.5 mm inside the strengthened glass sheet 10 from the initial crack 50). Here, the test pattern 3 corresponds to the second cutting initiation method described in the embodiment.

Meanwhile, in the test patterns 1 to 3, a fiber laser (central wavelength band in a range of 1075 nm to 1095 nm) was used as the light source of the laser beam. In addition, the beam radius of the laser beam was set to 0.2 (mm), the scanning rate was set to 2.5 (mm/s), and the laser output was set to 200 (W).

Next, the test results of the above-described test patterns 1 to 3 will be described. First, in the test pattern 1, the cracks extended in a deviant manner from the initial crack 50 to the end portion of the strengthened glass sheet 10 and from the initial crack 50 to the inside of the strengthened glass sheet 10, and the cutting of the strengthened glass sheet 10 did not stably initiate.

In the test pattern 2, the cutting of the strengthened glass sheet 10 did not initiate. This is considered to be because the laser beam began to be irradiated in the vicinity of the initial crack 50 such that a sufficient tensile stress did not act on the initial crack 50.

Meanwhile, in the test pattern 3, the crack extended from the initial crack 50 in the direction 57, and the cutting of the strengthened glass sheet 10 stably initiated. That is, in the test pattern 3, a tensile stress generated on the direction 56 side of the irradiation region 22 of the laser beam acted on the initial crack 50, and then the laser beam was scanned in the direction 57 which was opposite to the direction 56. Therefore, since it was possible to control the crack extended from the initial crack 50 in the direction 57 using the compressive stress generated in the irradiation region 22 of the laser beam, it was possible to stably initiate the cutting of the strengthened glass sheet 10.

### Example 3

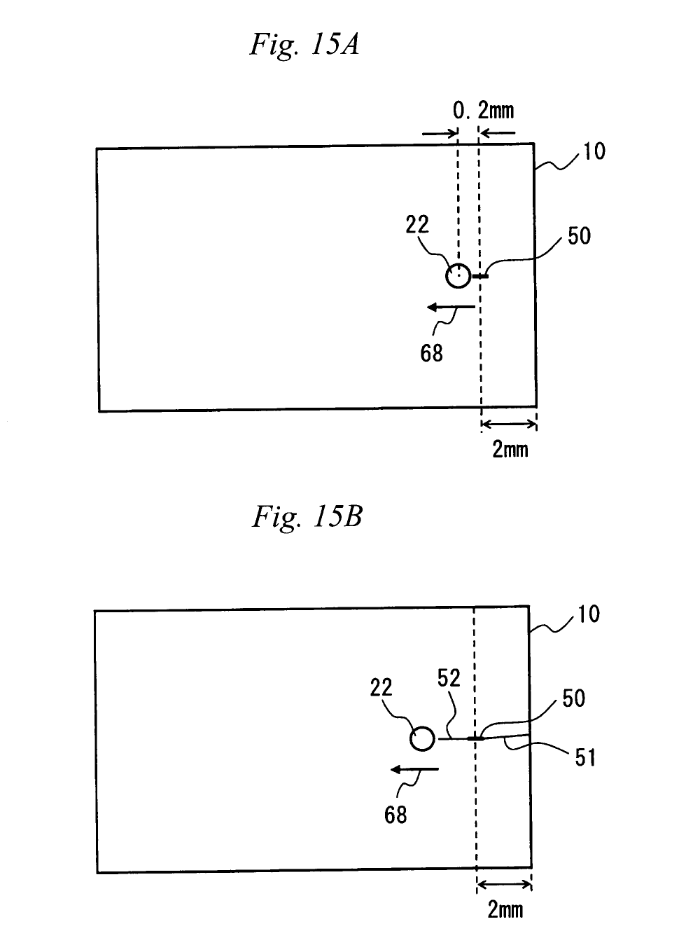

Next, Example 3 of the invention will be described. In Example 3, a strengthened glass sheet having a sheet thickness of 0.7 (mm) and an internal residual tensile stress CT of 57.2 (MPa) was used. In addition, the initial crack 50 was formed in advance 2 mm inside from the end portion of the strengthened glass sheet 10 as illustrated in FIG. 15A. The initial crack 50 was formed using a pulse laser.

In Example 3, the laser beam began to be irradiated with the center of the irradiation region 22 of the laser beam at a location 0.2 mm away from the initial crack 50, and the laser beam was scanned in the scanning direction 68 at the same time as illustrated in FIG. 15A. That is, the cutting initiation method of Example 3 corresponds to the third cutting initiation method described in the embodiment.

A fiber laser (central wavelength band in a range of 1075 nm to 1095 nm) was used as the light source of the laser beam. In addition, the beam radius of the laser beam was set to 0.2 (mm), the scanning rate was set to 0.5 (mm/s), and the laser output was set to 150 (W).

FIG. 15B is a view for describing the results of the cutting of the strengthened glass sheet 10 initiated using the third cutting initiation method. In a case where the third cutting initiation method was used as illustrated in FIG. 15B, the crack 51 extended in a deviant manner from the initial crack 50 toward the end portion of the strengthened glass sheet 10. In addition, the crack 52 extended from the initial crack 50 in the scanning direction 68. That is, in a case where the third cutting initiation method was used, it is possible to exert the tensile stress generated behind the irradiation region 22 of the laser beam in the scanning direction, on the initial crack 50, and it was possible to initiate the cutting of the strengthened glass sheet 10. After that, the crack 52 extended in the scanning direction 68 from the initial crack 50 was controlled using the compressive stress generated in the irradiation region 22 of the laser beam, whereby it was possible to stably initiate the cutting of the strengthened glass sheet 10.

The invention has been described using the embodiment, but the invention is not limited to the configuration of the embodiment, and it is needless to say that the invention includes a variety of modifications, corrections and combinations that can be imagined by those skilled in the art within the scope of the claims.

The present application is based on Japanese Patent Application No. 2011-189048 filed on Aug. 31, 2011, the content of which is incorporated herein by reference.

### DESCRIPTION OF REFERENCE NUMERALS AND SIGNS

10 STRENGTHENED GLASS SHEET
12 FRONT SURFACE
13 FRONT SURFACE LAYER
14 REAR SURFACE
15 REAR SURFACE LAYER
17 INTERMEDIATE LAYER
20 LASER BEAM
22 IRRADIATION REGION
24 SCANNING DIRECTION
25, 27, 29 COMPRESSIVE STRESS
26, 28 TENSILE STRESS
30 INITIAL CRACK
31 CRACK
32, 33 SCANNING DIRECTION
34, 36, 38, 40 COMPRESSIVE STRESS
35, 37, 39, 41 TENSILE STRESS
50 INITIAL CRACK
51, 52 CRACK
80 APPARATUS FOR CUTTING STRENGTHENED GLASS SHEET
81 LASER OUTPUT UNIT
82 GLASS HOLDING AND DRIVING UNIT
83 CONTROL UNIT
84 INITIAL CRACK-FORMING UNIT

1. A method for cutting a strengthened glass sheet in which a strengthened glass sheet comprising a front surface layer and a rear surface layer which have a residual compressive stress, and an intermediate layer which is provided between the front surface layer and the rear surface layer and has an inside residual tensile stress, is cut by moving an irradiation region of a laser beam to be irradiated on the strengthened glass sheet,
wherein, when initiating cutting of the strengthened glass sheet, a thermal stress which induces generation of a crack is exerted on a cutting initiation location in the strengthened glass sheet, and
extension of the crack is suppressed simultaneously with the generation of the crack at the cutting initiation location, and then the strengthened glass sheet is cut while suppressing extension of a crack caused by the inside residual tensile stress in the intermediate layer.

2. The method for cutting a strengthened glass sheet according to claim 1, wherein the intermediate layer in the irradiation region of the laser beam is heated at a temperature equal to or lower than an annealing point, and a tensile stress or a compressive stress which is smaller than a value of the inside residual tensile stress is generated in the intermediate layer in the irradiation region, whereby the strengthened glass sheet is cut while suppressing the extension of the crack caused by the inside residual tensile stress.

3. The method for cutting a strengthened glass sheet according to claim 1, wherein, in a case where an absorption coefficient of the strengthened glass sheet with respect to the laser beam is represented by α (cm⁻¹) and a thickness of the strengthened glass sheet is represented by t (cm), the strengthened glass sheet and the laser beam satisfy a formula of 0<α×t≦3.0.

4. The method for cutting a strengthened glass sheet according to claim 1, wherein, when initiating the cutting of the strengthened glass sheet, an irradiation energy per unit length of the laser beam to be irradiated on the strengthened glass sheet is set to be larger than the irradiation energy per unit length of the laser beam after the cutting of the strengthened glass sheet is initiated.

5. The method for cutting a strengthened glass sheet according to claim 1, wherein, when initiating the cutting of the strengthened glass sheet, a tensile stress acting on an initial crack formed at the cutting initiation location in the strengthened glass sheet is increased by setting the irradiation energy per unit length of the laser beam to be irradiated on the strengthened glass sheet to be larger than the irradiation energy per unit length of the laser beam after the cutting of the strengthened glass sheet is initiated.

6. The method for cutting a strengthened glass sheet according to claim 1, wherein the initial crack is formed at the cutting initiation location in the strengthened glass sheet,
a tensile stress generated behind the irradiation region of the laser beam in a scanning direction is exerted on the initial crack so as to initiate the cutting of the strengthened glass sheet, and
after the cutting of the strengthened glass sheet is initiated, the irradiation energy per unit length of the laser beam to be irradiated on the strengthened glass sheet is set to be smaller than the irradiation energy per unit length of the laser beam at a time of initiating the cutting of the strengthened glass sheet.

7. The method for cutting a strengthened glass sheet according to claim 1, wherein the cutting initiation location is a location inside at a predetermined distance from an end portion of the strengthened glass sheet, and the initial crack is formed at the cutting initiation location,
the laser beam is scanned in a first direction, and a tensile stress generated ahead of the irradiation region of the laser beam in the first direction is exerted on the initial crack,
the laser beam is scanned in a second direction that is opposite to the first direction, and the cutting of the strengthened glass sheet is initiated from a location of the initial crack using a tensile stress generated behind the irradiation region of the laser beam in the second direction, and
after the cutting of the strengthened glass sheet is initiated, the irradiation energy per unit length of the laser beam to be irradiated on the strengthened glass sheet is set to be smaller than the irradiation energy per unit length of the laser beam at a time of initiating the cutting of the strengthened glass sheet.

8. The method for cutting a strengthened glass sheet according to claim 4, wherein the irradiation energy per unit length of the laser beam is increased by increasing an output of the laser beam.

9. The method for cutting a strengthened glass sheet according to claim 4, wherein the irradiation energy per unit length of the laser beam is increased by decreasing a moving rate of the irradiation region of the laser beam.

10. The method for cutting a strengthened glass sheet according to claim 5, wherein a probability in which a tensile stress generated in a vicinity of the irradiation region of the laser beam acts on the initial crack is increased by increasing an area of the irradiation region of the laser beam.

11. An apparatus for cutting a strengthened glass sheet in which a strengthened glass sheet comprising a front surface layer and a rear surface layer which have a residual compressive stress, and an intermediate layer which is formed between the front surface layer and the rear surface layer and has an inside residual tensile stress, is cut by moving an irradiation region of a laser beam to be irradiated on the strengthened glass sheet, the apparatus comprising:
a glass holding and driving unit which holds the strengthened glass sheet and moves the strengthened glass sheet in a predetermined direction;
a laser output unit which outputs a laser beam for cutting the strengthened glass sheet;
an initial crack-forming unit which forms an initial crack at a cutting initiation location in the strengthened glass sheet; and
a control unit which controls the glass holding and driving unit, the laser output unit and the initial crack-forming unit.
